(19) United States
(12) Patent Application Publication
(10) Pub. No.: US 2022/0149702 A1
(43) Pub. Date: May 12, 2022

(54) ELECTRICAL MACHINE WITH CIRCUMFERENTIAL COOLING JACKET

(71) Applicant: Valeo Siemens eAutomotive Germany GmbH, Erlangen (DE)

(72) Inventors: Nils Krais, Bad Neustadt a.d.Saale (DE); Carl Philipp Jodokus Sontgerath, Bad Neustadt a.d.Saale (DE)

(73) Assignee: Valeo Siemens eAutomotive Germany GmbH, Erlangen (DE)

(21) Appl. No.: 17/521,644

(22) Filed: Nov. 8, 2021

(30) Foreign Application Priority Data
Nov. 9, 2020 (DE) 10 2020 214 044.8

(51) Int. Cl. H02K 9/197; H02K 5/20

(52) U.S. Cl. CPC H02K 9/197; H02K 5/203

(57) ABSTRACT

Described is an electrical machine (1, 1a) which comprises a first end shield (6, 6a) and a second end shield (7, 7a), a stator (5) which is arranged between the two end shields (6, 6a, 7, 7a) and has a stator laminated core (10) and stator windings (11) arranged therein, and a rotor (3) which is arranged in the stator (5) and has a rotor shaft (2, 2a) mounted rotatably in the two end shields (6, 6a, 7, 7a). The electrical machine (1, 1a) furthermore comprises a stator casing (8, 8a) which is arranged circumferentially around the stator (5) and which is mounted on the two end shields (6, 6a, 7, 7a) and which is spaced apart from the stator (5) at all points. Also specified is a vehicle (15) having an electrical machine (1, 1a) of said type.

### TECHNICAL FIELD

The invention relates to an electrical machine and to a vehicle having an electrical machine.

### PRIOR ART

In electrical machines, it is known to cool the stator in order to dissipate waste heat that accumulates during operation of the electrical machine from the stator. In some systems, cooling tubes are provided for this purpose in the stator, which cooling tubes are part of a cooling system and through which cooling tubes a heat transfer medium is passed. The cooling system may also comprise a pump for recirculating the heat transfer medium, and also a heat exchanger. A disadvantage of the known methods for producing a stator is that they are technically relatively complex and increase the cost of production of the electrical machine.

DISCLOSURE OF THE INVENTION

An object of the invention is therefore to describe an improved electrical machine and an improved vehicle. In particular, it is the intention for the cooling of the stator to be possible with lower technical outlay.

The object of the invention is achieved with an electrical machine which comprises
a first end shield and a second end shield,
a stator which is arranged between the two end shields and has a stator laminated core and stator windings arranged therein,
a rotor which is arranged in the stator and has a rotor shaft mounted rotatably in the two end shields, and
a stator casing which is arranged circumferentially around the stator and which is mounted on the two end shields and which is spaced apart from the stator at all points.

In other words, between the stator casing and the stator, there is formed a stator cooling channel through which a cooling medium can be passed. The stator casing may basically be regarded as part of a housing for the electrical machine, but because said stator casing is spaced apart from the stator at all points, said stator casing has no load-bearing function for the stator. The main function of the stator casing is instead that of delimiting the stator cooling channel. In general, the stator casing may be manufactured from a plastic, in particular from a fibre-reinforced plastic.

The stated object is also achieved by a vehicle comprising at least two axles, of which at least one is driven, wherein said drive is provided at least partially or for part of the time by the abovementioned electrical machine of the abovementioned type.

By means of the proposed measures, the disadvantages cited initially may be overcome. In particular, the cooling of a stator is made possible with lower technical outlay. Specifically, the stator cooling channel is delimited directly by the stator laminations of the stator laminated core and by the stator casing. Specially formed cooling channels in the stator laminated core, or additional cooling tubes, are not provided for this purpose. The electrical machine can therefore be of particularly simple and lightweight construction.

It is particularly advantageous if oil is provided as cooling medium, since this does not lead to corrosion of the stator laminations. For example, oil of a transmission on which the electrical machine is flange-mounted or in which the electrical machine is installed may be used as cooling medium. Waste heat from the electrical machine and also of the transmission is for example transported with the aid of the lubricating oil to a heat exchanger, and is released there to the surrounding environment. In this way, the electrical machine and the transmission are cooled. In this case, a combined cooling and lubricating circuit is provided, and oil is provided as cooling medium and lubricant. This means that the lubricating oil functions not only as a heat transfer medium, but also as a lubricant. The oil then satisfies multiple uses, in that it lubricates and cools the transmission and also cools the electrical machine. This is indeed advantageous, but not imperative. It is also conceivable that separate circuits are provided for lubrication and cooling. However, oil could also be provided as cooling medium for the electrical machine and the transmission in a separate cooling circuit of the transmission.

In a further favourable embodiment of the electrical machine, lines or channels for a cooling medium are arranged in the two end shields and are hydraulically connected to a stator cooling channel formed between the stator casing and the stator. A distributor to the stator cooling channel is thus formed in a first end shield, and a collector for collecting the cooling medium that has passed through the stator cooling channel and for returning said cooling medium into the return of the cooling circuit is formed in a second end shield.

It is furthermore expedient if the two end shields are connected to the stator with the aid of tie rods, wherein, in each of the two end shields, on each of both sides of each tie rod one line opens into the stator cooling channel. In this way, on the one hand, an undesired delamination of the stator laminations is prevented, and on the other hand, the stator cooling channel is uniformly passed through by the cooling medium.

It is finally advantageous if a surface of the stator casing which faces towards the stator is configured in the form of two frustum lateral surfaces facing towards one another, wherein the stator cooling channel formed between the stator casing and the stator narrows from end faces of the stator towards the centre. On the one hand, the stator casing can be easily demoulded if it is produced using a casting process, for example, and on the other hand, the cooling medium is accelerated in the central region of the stator, whereby the introduction of heat into the cooling medium is particularly intense there. In this way, the central region of the stator, which generally also constitutes a temperature-critical zone, is cooled particularly effectively.

The above embodiments and refinements of the invention may be combined in arbitrary fashion.

### BRIEF DESCRIPTION OF THE FIGURES

Exemplary embodiments of the invention are illustrated as examples in the appended schematic figures, in which:

FIG. 1 shows a schematic half-sectional view of an exemplary electrical machine;

FIG. 2 shows a somewhat more detailed view of an electric machine in a side view;

FIG. 3 shows the electrical machine from FIG. 2 in longitudinal section;

FIG. 4 shows the electrical machine from FIG. 2 in cross section;

FIG. 5 shows a detail of the longitudinal section illustrated in FIG. 3, and

FIG. 6 shows a schematic view of a vehicle with an electrical machine of the proposed type.

### DETAILED DESCRIPTION OF THE INVENTION

Initially, it is stated that identical parts in the different embodiments carry the same reference signs or same component designations, but in some cases with different indices. The disclosures of a component contained in the description may accordingly be transferred to another component with the same reference sign or same component designation. Also, the positional terms selected in the description, such as “top”, “bottom”, “rear”, “front”, “side” etc., relate to the figure directly described and depicted, and, in the event of a change in position, are to be transferred accordingly to the new position.

FIG. 1 shows a half section through a schematically illustrated electrical machine 1. The electrical machine 1 comprises a rotor shaft 2 with a rotor 3 (not illustrated in detail here) seated thereon, wherein the rotor shaft 2 is mounted by means of (rolling) bearings 4a, 4b so as to be rotatable about a rotational axis A relative to a stator 5. Specifically, the first bearing 4a is seated in a first end shield 6, and the second bearing 4b is seated in a second end shield 7. The electrical machine 1 furthermore comprises a stator casing 8, which is arranged circumferentially around the stator 5 and which is mounted on the two end shields 6, 7 and which is spaced apart from the stator 5 at all points. A stator cooling channel 9 is accordingly situated between the stator 5 and the stator casing 8.

The stator casing 8 may basically be regarded as a central housing part, but because said stator casing is spaced apart from the stator 5 at all points, said stator casing has no load-bearing function for the stator 5. The main function of the stator casing 8 is instead that of delimiting the stator cooling channel 9. In general, the stator casing 8 may be manufactured from a plastic, in particular from a fibre-reinforced plastic.

The stator 5 has a plurality of stator laminations (not illustrated in detail here), which form a stator laminated core 10 or a stator main body, and also stator windings 11 arranged in the stator laminated core 10. Furthermore, lines or channels 12a, 12b are arranged in the first end shield 6 and in the second end shield 7 and are hydraulically connected to the stator cooling channel 9 between the stator 5 and the stator casing 8.

The stator cooling channel 9 and also the lines or channels 12a, 12b are part of a cooling system (not illustrated in its entirety in FIG. 1) of the electrical machine 1.

The cooling system may in particular also have a pump for a heat transfer medium, and also a heat exchanger. For example, a water-glycol mixture circulating in the cooling system, or oil, may be used as heat transfer medium.

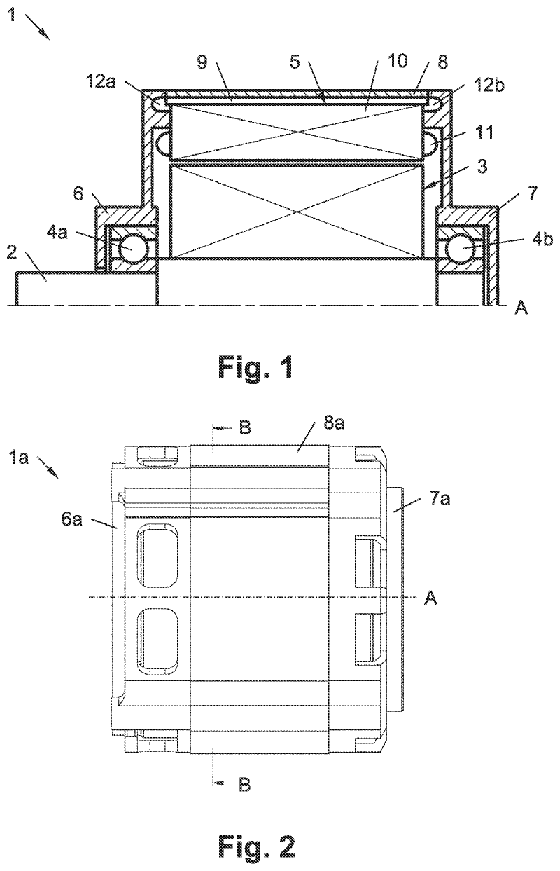

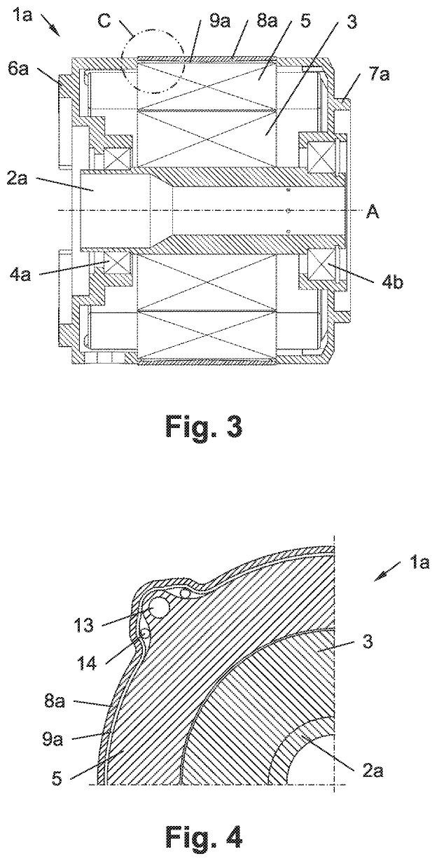

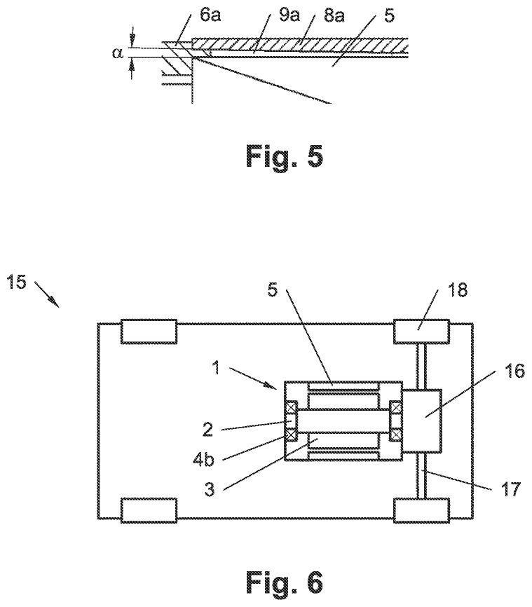

FIGS. 2 to 5 now show an electrical machine 1a illustrated in somewhat more detail. Specifically, the electrical machine 1a is shown in FIG. 2 in a side view, in FIG. 3 in longitudinal section, and in FIG. 4 in cross section in the section plane BB. FIG. 5 furthermore shows a detail C of the longitudinal section illustrated in FIG. 3.

The electrical machine 1a has, in particular, a somewhat differently shaped rotor shaft 2a, which in this example is hollow, and somewhat differently shaped end shields 6a, 7a.

In the example shown in FIGS. 2 to 5, the two end shields 6a, 7a are furthermore connected to the stator 5 with the aid of tie rods. FIGS. 2 to 5 do not illustrate the tie rods, but illustrate only bores 13 that receive these. Additionally, in each of the two end shields 6a, 7a, on each of both sides of each tie rod or bore 13 respectively, one line 14 opens into the stator cooling channel 9a.

Furthermore, in the case of the electric machine 1a, a surface of the stator casing 8a which faces towards the stator 5 is configured in the form of two frustum lateral surfaces facing towards one another, wherein the stator cooling channel 9a formed between the stator casing 8a and the stator 5 narrows in tapering fashion from the end faces of the stator 5 towards the centre. There is accordingly the angle a between the stator 5 and the stator casing 8a. By means of the proposed measures, the stator casing 8a can on the one hand be easily demoulded if it is produced using a casting process, for example, and on the other hand, the cooling medium is accelerated in the central region of the stator 5, whereby the introduction of heat into the cooling medium is particularly intense there. In this way, the central region of the stator 5, which generally also constitutes a temperature-critical zone, is cooled particularly effectively.

FIG. 6 finally shows an electrical machine 1 installed in a vehicle 15. The vehicle 15 has at least two axles, at least one of which is driven. Specifically, the electrical machine 1 is connected to the half-axles 17 of the rear axle via an optional transmission 16. Finally, the driven wheels 18 are mounted on the half-axles 17. The drive of the vehicle 15 is provided at least partially or for part of the time by the electrical machine 1. This means that the electrical machine 1 may serve for exclusively driving the vehicle 15, or for example may be provided in conjunction with an internal combustion engine (hybrid drive).

Finally, it is established that the scope of protection is determined by the patent claims. The description and the drawings should however serve as reference for interpretation of the claims. The features contained in the figures may be interchanged and combined with one another arbitrarily. In particular, it is also established that the devices illustrated may in reality comprise more or also fewer constituents than illustrated. In some cases, the illustrated devices or their constituents may also not be illustrated to scale, and/or may be enlarged and/or reduced.

1. An electrical machine (1, 1a), comprising:
a first end shield and a second end shield;
a stator which is arranged between the two end shields and has a stator laminated core and stator windings arranged therein; and
a rotor which is arranged in the and has a rotor shaft mounted rotatably in the two end shields;
a stator casing which is arranged circumferentially around the stator and which is mounted on the two end shields and which is spaced apart from the stator at all points.

2. The electrical machine according to claim 1, wherein lines or channels for a cooling medium are arranged in the two end shields and are hydraulically connected to a stator cooling channel formed between the stator casing and the stator.

3. The electrical machine according to claim 2, wherein the two end shields are connected to the stator with the aid of tie rods, and, in each of the two end shields, on each of both sides of each tie rod one line opens into the stator cooling channel.

4. The electrical machine according to claim 1 wherein a surface of the stator casing which faces towards the stator is configured in the form of two frustum lateral surfaces facing towards one another, wherein the stator cooling channel formed between the stator casing and the stator narrows from end faces of the stator towards the centre.

5. The electrical machine according to claim 1, wherein the stator casing is manufactured from a plastic, in particular from a fibre-reinforced plastic.

6. A vehicle with at least two axles, of which at least one is driven, wherein said drive is provided least partially or for part of the time by the electrical machine according to claim 1.
